(19) United States
(12) Patent Application Publication
(10) Pub. No.: US 2009/0135157 A1
(43) Pub. Date: May 28, 2009

(54) Capacitive Sensing Input Device with Reduced Sensitivity to Humidity and Condensation

(75) Inventor: Jonah Harley, Mountain View, CA (US)

Correspondence Address: Kathy Manke;Avago Technologies Limited, 4380 Ziegler Road, Fort Collins, CO, 80525, US

(73) Assignee: Avago Technologies ECBU IP (Singapore) Pte. Ltd., Singapore (SG)

(21) Appl. No.: 11/945,832

(22) Filed: Nov. 27, 2007

(51) Int. Cl. G06F 3/045

(52) U.S. Cl. 345/174

(57) ABSTRACT

A capacitive sensing input device particularly well adapted for use in electronic devices such as portable computers, PDA's, cell phones, MP3 players and the like is disclosed that has reduced sensitivity to humidity and condensation. One or more fixed potential or ground conductors are placed between a sense electrode and a drive electrode. The fixed potential or ground conductors are configured in respect of the sense and drive electrodes to intercept or block undesired electrical fields or signals resulting from condensation or humidity.

### FIELD OF THE INVENTION

Various embodiments relate to the field of capacitive sensing input devices generally, and in some embodiments to capacitive sensing input devices for portable or hand-held devices such as pointing devices mice, cell phones, MP3 players, personal computers, game controllers, laptop computers, PDA's and the like. Embodiments include those finding application in stationary, portable and hand-held devices, as well as those related to the fields of industrial controls, washing machines, exercise equipment, and other devices. Still further embodiments relate to capacitive sensing input devices where resistance to high-humidity conditions is desirable.

### BACKGROUND

Capacitive sensing input devices such as some AVAGO™ input devices, the CYPRESS™ PSOC capacitive sensor and some types of TOUCHPAD™ devices can exhibit undesired response characteristics in the presence of humidity, which can affect sensing accuracy and result in missed touch signals or false positive touch signals. Especially in the case of puck-based capacitive input devices such as the AVAGO AMRT-1410, a baseline “no touch” level often varies with changes in ambient humidity. In some capacitive sensing input devices, one approach to problems induced by changes in ambient humidity is to use algorithms that implement filtering techniques to distinguish between signals induced by changes in ambient humidity from those associated with a user's touch. In such algorithms, slowly changing signals are assumed to be the result of humidity or temperature variations and are therefore ignored. More rapid changes are assumed to originate from a user's finger. Such filtering techniques are susceptible to failure or fault, either through rapidly changing ambient humidity conditions (e.g., leaving an air-conditioned building) or slowly changing input signals that are not tracked.

Another solution to the problem of changing ambient humidity conditions is to include a separate humidity sensor in a device and use information provided by the sensor to compensate for signal drift.

What is needed is a capacitive sensing input device insensitive to changes in ambient humidity or high humidity conditions, which can accurately and consistently detect a user's touch.

Further details concerning various aspects of prior art devices and methods are set forth in: (1) U.S. patent application Ser. No. 11/488,559 entitled “Capacitive Sensing in Displacement Type Pointing” to Harley filed Jul. 18, 2006; (2) U.S. patent application Ser. No. 11/606,556 entitled “Linear Positioning Input Device” to Harley filed Nov. 30, 2006; (3) U.S. Provisional Patent Application Ser. No. 60/794,723 entitled “Linear Positioning Device” to Harley filed Apr. 25, 2006, and (4) U.S. patent application Ser. No. 10/723,957 entitled “Compact Pointing Device” to Harley filed Nov. 24, 2003, each of which is hereby incorporated by reference herein, each in its respective entirety.

### SUMMARY

In one embodiment, there is a provided a capacitive sensing input device comprising at least one substrate, a drive electrode disposed on the substrate, at least one sense electrode disposed on the substrate and electrically isolated from the drive electrode, at least portions of the sense electrode being separated from the drive electrode by a first gap, at least one electrically conductive fixed potential or ground conductor disposed in at least portions of the first gap between the sense electrode and the drive electrode, an electrically insulative touch surface disposed above the substrate, the drive electrode and the sense electrode, the touch surface being separated from the drive electrode by a second gap, where the sense electrode, the drive electrode, the fixed potential or ground conductor and the touch surface are configured respecting one another to at least one of prevent, inhibit and diminish direct electrical coupling through water or water vapor disposed between the sense electrode and the drive electrode or atop, beneath or adjacent to the touch surface.

In another embodiment, there is provided a capacitive sensing input device comprising at least one substrate, a drive electrode disposed on the substrate, at least one sense electrode disposed on the substrate and electrically isolated from the drive electrode, at least portions of the sense electrode being separated from the drive electrode by a first gap, at least one electrically conductive fixed potential or ground conductor disposed in at least portions of the first gap between the sense electrode and the drive electrode, an electrically conductive sense plate disposed above the substrate, the drive electrode and the sense electrode, the sense plate being separated from the drive electrode by a second gap, where the sense electrode, the drive electrode, the fixed potential or ground conductor and the sense plate are configured respecting one another to at least one of prevent, inhibit and diminish direct electrical coupling through water or water vapor disposed between the sense electrode and the drive electrode or atop, beneath or adjacent to the sense plate.

In a further embodiment there is provided a method of making a capacitive sensing input device comprising providing at least one substrate, providing a drive electrode and disposing the drive electrode on the substrate, providing at least one sense electrode and disposing the sense electrode on the substrate such that the sense electrode is electrically isolated from the drive electrode and at least portions of the sense electrode are separated from the drive electrode by a first gap, providing at least one electrically conductive fixed potential or ground conductor and disposing the ground conductor in at least portions of the first gap between the sense electrode and the drive electrode, providing an electrically insulative touch surface and positioning the touch surface above the substrate, the drive electrode and the sense electrode such that the touch surface is separated from the drive electrode by a second gap, and configuring the sense electrode, the drive electrode, the fixed potential or ground conductor and the touch surface respecting one another to at least one of prevent, inhibit and diminish direct electrical coupling through water or water vapor disposed between the sense electrode and the drive electrode or atop, beneath or adjacent to the touch surface.

In yet another embodiment, there is provided a method of making a capacitive sensing input device comprising providing at least one substrate, providing a drive electrode and disposing the drive electrode on the substrate, providing at least one sense electrode and disposing the sense electrode on the substrate such that the sense electrode is electrically isolated from the drive electrode and at least portions of the sense electrode are separated from the drive electrode by a first gap, providing at least one electrically conductive fixed potential or ground conductor and disposing the ground conductor in at least portions of the first gap between the sense electrode and the drive electrode, providing an electrically conductive sense plate and disposing the sense plate above the substrate, the drive electrode and the sense electrode such that the sense plate is separated from the drive electrode by a second gap, and configuring the sense electrode, the drive electrode, the fixed potential or ground conductor and the sense plate respecting one another to at least one of prevent, inhibit and diminish direct electrical coupling through water or water vapor disposed between the sense electrode and the drive electrode or atop, beneath or adjacent to the sense plate.

In still another embodiment, there is provided a method of preventing, inhibiting or diminishing direct electrical coupling through water or water vapor disposed between a sense electrode and a drive electrode comprising providing at least one electrically conductive fixed potential or ground conductor and disposing the fixed potential or ground conductor in at least portions of a gap between the sense electrode and the drive electrode, and configuring the sense electrode, the drive electrode and the fixed potential or ground conductor respecting one another to at least one of prevent, inhibit and diminish direct electrical coupling through water or water vapor disposed between the sense electrode and the drive electrode.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 shows a top plan view of electrode array 59 comprising outer sense electrodes 50, 52, 54 and 56 and drive electrode 60;

FIG. 2 shows portions of one embodiment of capacitive sensing input device 19 comprising electrically conductive sense plate 20 spaced vertically apart from sense electrodes 50, 52, 54 and 56 and drive electrode 60;

FIG. 3 shows a cross-sectional view of one embodiment of solid-state capacitive sensing input device 19 comprising electrode array 59 and substrate 30;

FIG. 4 illustrates undesired electrical coupling occurring between drive electrode 60 and sense electrode 54;

FIG. 5 shows a top plan view of electrode array 59 according to one embodiment;

FIG. 6 shows a partial cross-sectional view of electrode array 59 of FIG. 5.

FIG. 7 is a top plan view of the upper surface of portable device 10 employing input device 19 according to one embodiment;

FIG. 8 illustrates one embodiment of electrode array 59 and its connection to capacitance sensing circuit 104, host processor 102 and display 14.

FIG. 9 shows a capacitive sense switch or button of the prior art; and

FIG. 10 shows one embodiment of a capacitive sense switch or button.

The drawings are not necessarily to scale. Like numbers refer to like parts or steps throughout the drawings.

### DETAILED DESCRIPTIONS OF SOME PREFERRED EMBODIMENTS

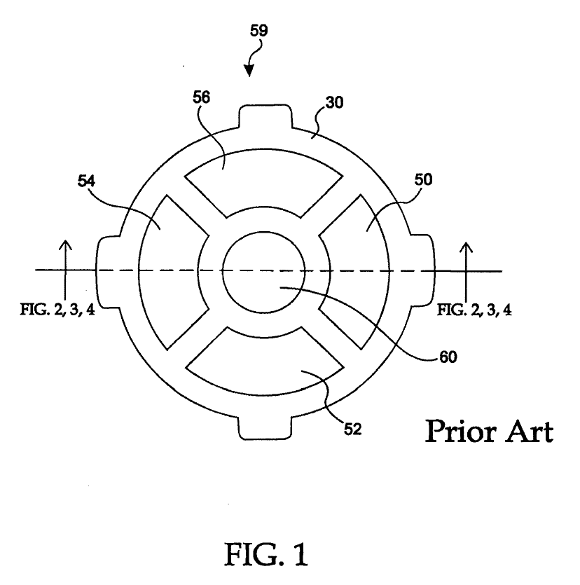

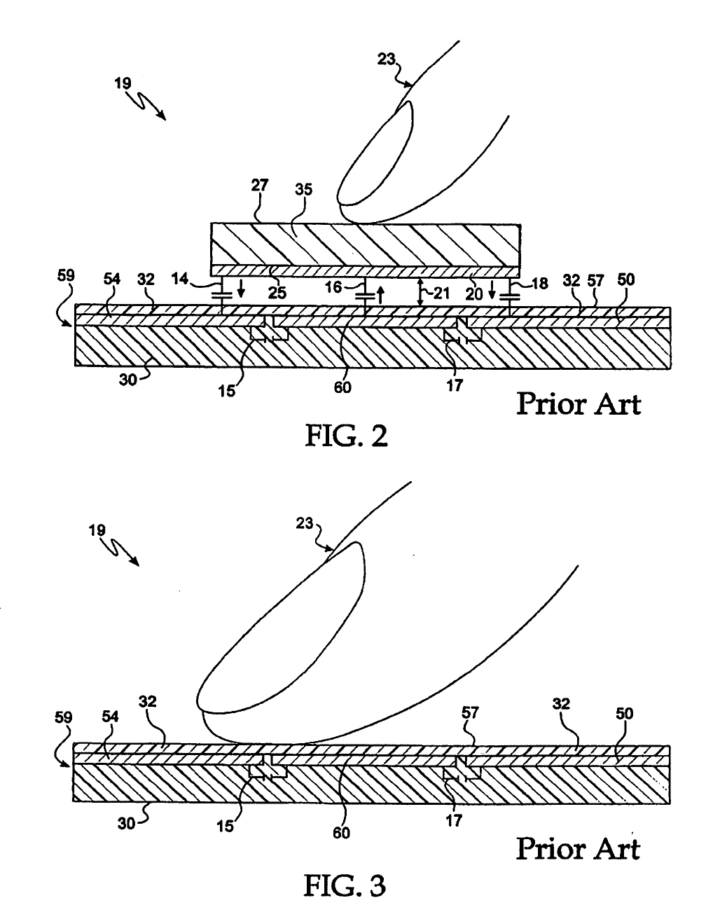

Referring first to FIGS. 1 and 2, in many commercial applications such as mobile telephones, the AVAGO™ input devices mentioned hereinabove typically comprise three main sets of components: (1) electrode array 59 disposed atop substrate 30; (2) a puck assembly that includes sense plate 20, overlies electrode array 59 and substrate 30, is laterally moveable by users finger 23 in respect of underlying electrode array 59 and substrate 30, and optionally has a central portion thereof that is downwardly deflectable in the direction of underlying electrode array 59; and (3) an integrated circuit comprising capacitance sensing circuit 104 for delivering a drive signal to central drive electrode 60, and for sensing changes in capacitance respecting sense electrodes 50, 52, 54 and 56.

These three sets of components are typically customized according to the particular dimensional and operational specifications set by a mobile device manufacturer, and are typically delivered as discrete sets of components to the manufacturer for operable interconnection and assembly thereby. Movement of the puck assembly laterally or vertically in respect of underlying electrode array 59 results in changes in the capacitances of, and/or the ratios of capacitance between, sense electrodes 50, 52, 54, and 56 disposed beneath the puck. Lateral movement of the puck is typically limited, by way of illustrative example only, to between about 1 mm and about 3 mm, or between about 10 mm and about 20 mm, depending on the particular application at hand, although the amount of lateral movement permitted may of course be smaller or greater. Other ranges of movement are of course contemplated. Such lateral or vertical movement of the puck assembly (which includes sense plate 20 attached thereto) is detected by capacitance sensing circuit 104, and is typically be employed to generate navigation information, scrolling and/or clicking functionality in the mobile device. The puck assembly is preferably configured to be returned to a central resting position atop electrode array 59 by a biasing spring mechanism when user's finger 23 is removed therefrom. Further details concerning such a device are set forth in U.S. patent application Ser. No. 10/723,957 entitled “Compact Pointing Device” to Harley filed Nov. 24, 2003, the entirety of which is hereby incorporated by reference herein.

FIG. 1 shows a top plan view of electrode array 59 comprising outer sense electrodes 50, 52, 54 and 56 and drive electrode 60. Electrode array 59 is disposed atop and/or in substrate 30. Electrode array 59 and substrate 30 illustrated in FIG. 1 are similar to those employed in AVAGO™ devices such as the AMRT-1410 or AMRT-2325. In the embodiment illustrated, substrate 30 is provided with four peripheral pie-shaped electrodes 50, 52, 54, and 56 and drive electrode 60, all of which are preferably fabricated from a layer of conductive metal (preferably copper or gold-plated copper) disposed on or in substrate 52 according to any of various techniques described below, or using other suitable techniques known to those skilled in the art. Suitable formulations of indium tin oxide (ITO) may also be employed to form such electrodes.

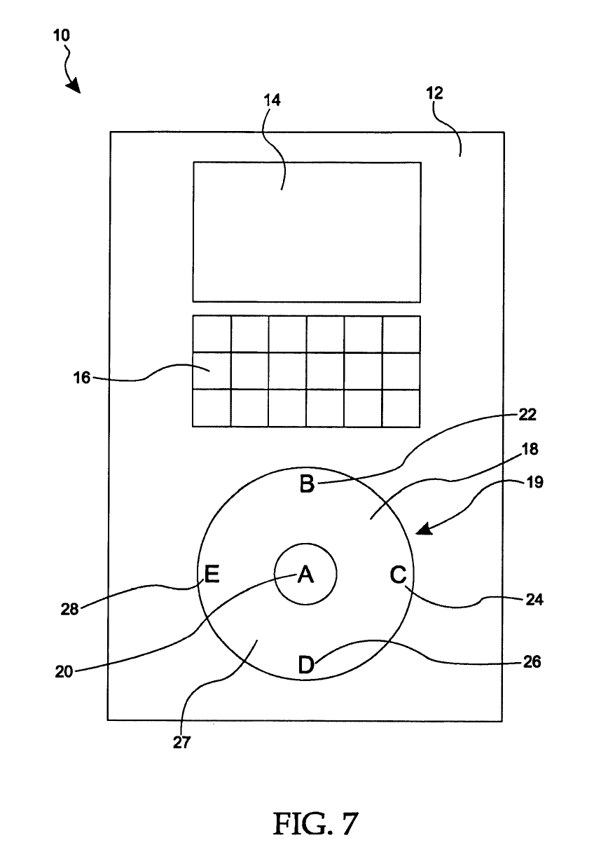

FIG. 2 shows portions of one embodiment of capacitive sensing input device 19 comprising electrically conductive sense plate 20 overlying, and in a central resting position spaced vertically apart from, sense electrodes 50, 52, 54 and 56 and drive electrode 60. Lateral movement of sense plate 20 (which forms a portion of a puck assembly not otherwise shown in FIG. 2) changes relative capacitances 14 and 18 between peripheral electrodes 50 and 54. In a preferred embodiment, sense electrodes 50, 52, 54 and 56 are continuously capacitively coupled to central drive electrode 60 through sense plate 20 such that capacitance changes occurring therebetween may be detected by capacitance sensing circuit 104 (not shown in FIG. 1 or 2). As mentioned above, for purposes of clarity a complete puck assembly (which includes sense plate 20) is not illustrated in FIG. 2. In actual practice, a puck assembly that includes sense plate 20, overlies electrode array 59 and substrate 30, and is laterally moveable by user's finger 23 in respect of underlying electrode array 59 and substrate 30, and optionally has a central portion 20 thereof that is downwardly deflectable in the direction of underlying electrode array 59, is provided that includes upper surface 27 shown in FIGS. 2 and 7.

In addition to sensing lateral motion of sense plate 20, electrode array 59 may also be configured to detect vertical deflection of sense plate 20 towards drive electrode 60 through the action of user's finger 23 pressing downwardly upon electrically insulative cover 35 having tip surface 27. In one configuration of device 19, a vertical force applied by user's finger 23 depresses a central portion of sense plate 60 to cause a reduction in the thickness of gap 21 disposed between sense plate 20 and drive electrode 60, which in turn effects a change in the capacitance between sense plate 20 and sense electrodes 50, 52, 54 and 56. Such sensing of the vertical deflection of sense plate 20 may be used, by way of example, to enhance navigation algorithms and/or to provide clicking or scrolling functionality to capacitive sensing input device 19. In one embodiment, gap 21 is about 200 microns in thickness, and a center portion of sense plate 20 is bowed slightly upwards; when pressed downwards by user's finger 23, sense plate 20 flattens out, and if pressed further downwardly, further increases the capacitance between drive electrode 60 and sense plate 20, thereby allowing the detection of a click signal, for example.

The embodiment of device 19 illustrated in FIG. 2 operates in accordance with the principles of mutual capacitance, or capacitance occurring between two opposing charge-holding surfaces (e.g., between sense plate 20 and drive electrode 60, and between sense plate 20 and sense electrodes 50, 52, 54 and 56) in which charge on one surface causes charge buildup on an opposing surface across the gap disposed therebetween (e.g., gaps 21 or 29). In FIG. 2, for example, sense plate 20 capacitively couples charge from drive electrode 60 to sense electrodes 50 and 54. In the arrangement shown in FIG. 2, capacitances 14, 16 and 18 are established between sense plate 20 and sense electrode 54, drive electrode 60 and sense plate 20, and sense plate 20 and sense electrode 50, respectively. That is, during operation of mutual capacitance input device 19 illustrated in FIG. 2, some portion of the charge corresponding to the drive signal is mirrored across gap 21 between drive electrode 60 and sense plate 20, and across gaps 29 between sense plate 20 and sense electrodes 50, 52, 54 and 56, thereby effecting capacitances 16, 14 and 18 therebetween.

Capacitances 15 and 17 illustrated in FIG. 2 are also typically established between sense electrode 54 and drive electrode 60, and between drive electrode 60 and sense electrode 50, respectively. A drive waveform is input to drive electrode 60. Electrically conductive sense plate 20 couples the drive signal from drive electrode 60 to sense electrodes 50, 52, 54 and 56. As sense plate 20 is moved laterally by user's finger 23 above drive and sense electrodes 60 and 50-56, the ratio of the drive signal coupled to the respective individual sense electrodes 50, 52, 54 and 56 varies, thereby providing a two-dimensional measurement of the position of user's finger 23 as it moves sense plate 20 laterally over electrode array 59. In one embodiment, when sense plate 20 is in a resting or centered position, the capacitance effected between drive electrode 60 and sense plate 20, and between sense plate 20 and the various sense electrodes 50, 52, 54 and 56, is about 2 pF each, resulting in a nominal series capacitance of about 1 pF. Movement of sense plate 20 from the resting or centered position changes those capacitances, with some capacitances growing larger and others smaller, depending, of course, on the relative positions of sense plate 20 and sense electrodes 50, 52, 54 and 56. In a preferred embodiment of a mutual capacitance device similar to that illustrated in FIG. 2, gap 21 ranges between about 0.1 mm and about 1 mm.

Continuing to refer to FIG. 2, in preferred embodiments, substrate 30 is preferably a printed circuit board and in one embodiment comprises FR-4 fiberglass, although many other materials and compositions suitable for use in printed circuit boards may also be used, such as glass, FR-2 fiberglass, polyimide, GETEK™, BT-epoxy, cyanate ester, PYRALUX™, polytetrafluoroethylene (PTFE) or ROGERS BENDFLEX™. In a preferred embodiment, substrate 30 has electrically conductive conductors formed of copper, ITO, electrically conductive polymers, plastics, epoxies or adhesives, or any another suitable metal or electrically conductive material disposed thereon or therein, which may be formed by any of a number of methods known to those skilled in the art, such as silk screen printing, photoengraving with a photomask and chemical etching, PCB milling and other suitable techniques.

As illustrated in FIG. 2, sense plate 20 is disposed between upper surface 27 of device 19 and top surface 57 of electrode array 59, and may be separated therefrom by an optional flexible membrane (more about which is said below). Sense plate 20 is preferably thin (e.g., about 0.1 mm in thickness) and formed of a strong, flexible, light material such as stainless steel or any other suitable metal or material. Sense plate 20 may assume any of a number of different physical configurations or shapes, such as a series of discrete strips or members electrically connected to one another, a disc, a plate, a circle, an ovoid, a square, a rectangle, a cross-shaped member, a star-shaped member, a pentagon, a hexagon, an octagon, or any other suitable shape or configuration. Sense plate 20 may also have an electrically conductive coating, such as a clear conductor like indium tin oxide or ITO to facilitate illumination from a light guide disposed beneath sense plate 20, paint, polymer, adhesive, epoxy or any other suitable material disposed thereon.

In an embodiment particularly well suited for use in a portable electronic device such as a mobile telephone, representative values for the diameter of sense plate 20 range between about 10 mm and about 50 mm, with diameters of about 12 mm, about 14 mm, about 16 mm, about 18 mm, about 20 mm, about 30 mm and about 40 mm being preferred. Other diameters of sense plate 20 are of course contemplated. In many embodiments, the diameter of sense plate 20 is small enough to stay within the boundaries of electrode array 59 during lateral motion, yet large enough to cover at least some portion of central drive electrode 60.

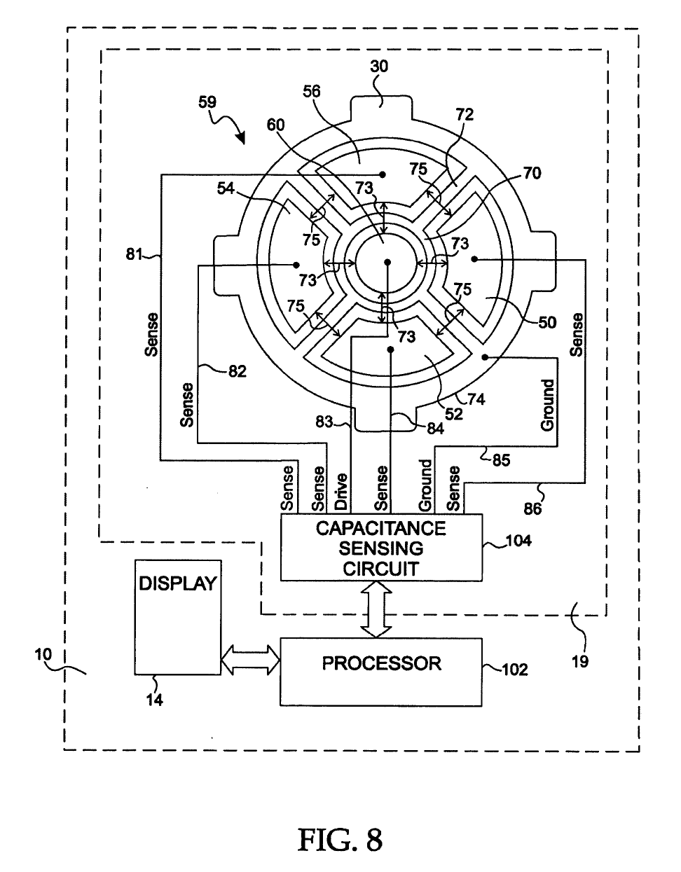

An optional flexible membrane may be disposed between upper surface 27 of device 19 and top surface 57 of electrode array 59 (see FIGS. 2 and 8). Such a flexible membrane may be employed and configured to impart leak-tightness, leak resistance, gas-tightness, gas resistance, or vapor-tightness or vapor resistance to device 10 such that liquid or gas spilled or otherwise coming into contact with capacitive sensing input device 19 or portable device 10 cannot enter, or is inhibited from entering, the interior of device 10 to damage, hinder or render inoperable the electrical and electronic circuit disposed therewithin. Such a flexible membrane may also be configured to permit underwater operation of device 10. Similarly, flexible membrane may be configured to protect the electrical and electronic components disposed within housing 12 from the deleterious effects of salt-laden air or other harmful gases or vapors, such as is commonly found in ocean or sea environments, or from mud, dirt or other particulate matter such as dust or air-borne contaminants or particles.

In some embodiments not illustrated in the Figures hereof, an optional light guide layer of conventional construction may be disposed between upper surface 27 and sense plate 20 or electrode array 59, and is configured to allow light to shine through any translucent or transparent areas that might be disposed in and/or around capacitive sensing input device 19. Alternatively, such a light guide may be disposed beneath sense plate 20 or above electrode array 59.

Referring now to FIG. 3, there is shown a cross-sectional view of a solid-state capacitive sensing input device 19 comprising electrode array 59 and substrate 30, with layer 32 disposed over the top of electrode array 59; no sense plate 20 is disposed over electrode array 59 in the embodiment of device 19 illustrated in FIG. 3. Instead, only layer 32 is disposed over electrode array 59, where layer 32 preferably comprises an electrically insulative material such as glass or plastic and generally has a thickness exceeding that of the embodiment illustrated in FIG. 2 (which may comprise a relatively thin solder mask layer only, which typically ranges between about 10 microns and about 30 microns in thickness). Note that in some preferred embodiments, layer 32 such as that illustrated in the embodiment of FIG. 3 ranges between about 0.3 mm and about 5 mm in thickness.

The embodiment of device 19 illustrated in FIG. 3 also operates in accordance with the principles of mutual capacitance. As in the embodiment illustrated in FIG. 2, capacitances 15 and 17 are also typically established between sense electrode 54 and drive electrode 60, and between drive electrode 60 and sense electrode 50, respectively, as further illustrated in FIG. 3. A drive waveform is input to drive electrode 60. User's finger 23 is typically at or near electrical ground, and engages touch surface 57. When in contact with touch surface 57, user's finger 23 couples to the drive signal provided by drive electrode 60 and proportionately reduces the amounts of capacitances 15 and 17. That is, as user's finger 23 moves across touch surface 57, the ratio of the drive signal coupled to the respective individual sense electrodes 50, 52, 54 and 56 through finger 23 is reduced and varied, thereby providing a two-dimensional measurement of a position of user's finger 23 above electrode array 59. Other sense and drive electrode configurations may also be employed in such an embodiment.

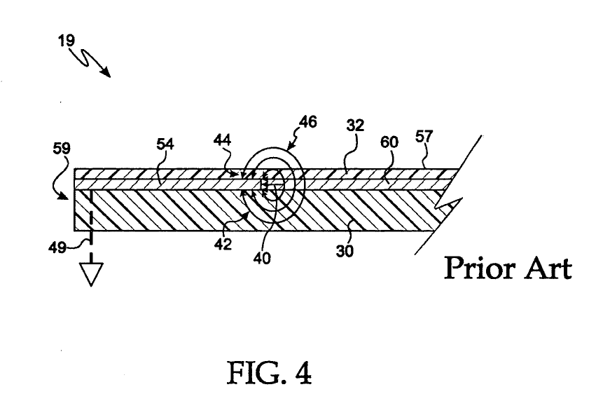

Referring now to FIG. 4, it has been discovered that undesired capacitive coupling may occur between drive electrode 60 and sense electrodes 50, 52, 54 and 56, especially under high humidity conditions or when condensation forms on touch surface 57, or between sense plate 20 and electrode array 59, and that such undesired capacitive coupling appears to occur largely independent of sense plate 20 (if present). Such undesired capacitive coupling between drive electrode 60 and any or more of sense electrodes 50, 52, 54 and 56 may occur through any one or more of: (1) electric field coupling 42 occurring through substrate 30 (which is typically a printed circuit board or PCB); (2) electric field coupling 40 occurring through solder mask or other covering or layer 32; and/or (3) electric field coupling 46 occurring through air above electrode array 59. When humidity or condensation increases, additional and sometimes significantly increased coupling to all sense electrodes 50, 52, 54 and 56 is observed. This additional undesired signal can induce errors in proper operation of the aforementioned touch and click detection algorithms.

Although humid air has a dielectric constant greater than that of dry air, the contribution of humidity to the above-described undesired capacitive signal appears to be quite small, and therefore probably does not contribute significantly to the observed increase in such undesired capacitive signals. Instead, the primary contribution to undesired capacitive signals seems to arise from condensation forming on layer 32 (which typically comprises a solder mask), which essentially shorts the field lines between drive electrode 60 and sense electrodes 50, 52, 54 and 56.

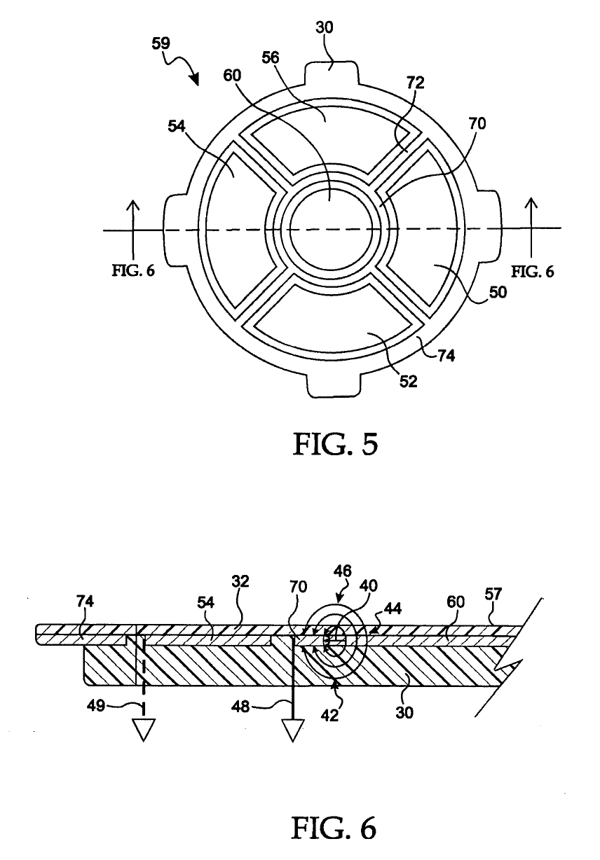

Solutions to at least some of the foregoing problems spawned by humidity and condensation are provided by disposing one or more of electrically conductive fixed potential or ground traces 70, 72 or 74 between drive electrode 60 and sense electrodes 50, 52, 54 and 56, and/or around drive electrode 60 or sense electrodes 50, 52, 54 or 56, as illustrated in FIGS. 5 and 6. FIG. 5 shows a top plan view of circular electrode array 59 according to one embodiment, where electrode array 59 comprises outer sense electrodes 50, 52, 54 and 56, central drive electrode 60 and substrate 30, and further comprises electrically conductive fixed potential or ground conductors 70, 72 and 74, which are disposed between and around drive electrode 60 and sense electrodes 50, 52, 54 and 56. As shown in FIG. 5, drive electrode 60 is separated from adjoining sense electrodes 50, 52, 54 and 56 by ring-shaped first electrically conductive fixed potential or ground conductor 70. In preferred embodiments, gaps located between the outer periphery of drive electrode 60 and the edges of first fixed potential or ground conductor 70 range between about 0.075 mm and about 0.5 mm in width. Also in preferred embodiments, first fixed potential or ground conductor 70 ranges between about 0.075 mm and about 1 mm in width. As further shown in FIG. 5, second fixed potential or ground conductors 72 are disposed between sense electrodes 50, 52, 54 and 56, and are electrically and physically connected to first fixed potential or ground conductor 70. Third ground fixed potential or conductor 74 surrounds the outer peripheries of sense electrodes 50, 52, 54 and 56 and is electrically and physically connected to second fixed potential or ground conductors 72. Thus, first, second and third fixed potential or ground conductors 70, 72 and 74 form a web of interconnected electrical conductors all connected electrically to a fixed potential or electrical ground that are interposed between drive electrode 60 and sense electrodes 50, 52, 54 and 56, and between sense electrodes 50, 52, 54 and 56. In some preferred embodiments, the gap ranges between adjoining sense or drive electrodes may range between about 0.2 mm and about 2 mm, between about 0.15 mm and about 3 mm, and between about 0.10 mm and about 4 mm.

Referring now to FIG. 6, there is shown a partial cross-sectional view of electrode array 59 disposed on substrate 30 illustrated in FIG. 5. As shown in FIG. 6, first fixed potential or ground conductor 70 intercepts electric fields 40, 42, 44 and 46 emanating from the edge of sense electrode 60 before such fields can couple electrically to adjoining sense electrode 54. The addition of ground conductor 70 to electrode array 59 interrupts field lines and blocks direct electrical coupling between drive electrode 60 and sense electrodes 50, 52, 54 and 56. The effects of changing humidity, increasing humidity and condensation on or in the vicinity of top surface 57 on the performance of electrode array 59 are thus virtually eliminated by providing appropriately configured and spaced fixed potential or ground conductors 70, 72 and 74 between drive electrode 60 and sense electrodes 50, 52, 54 and 56. Note that fixed potential or ground conductors 70, 72 and 74 need not be held at electrical ground to perform their undesired electrical field interception function, and instead may be held at any suitable fixed voltage or potential to accomplish substantially the same function.

In one embodiment, each of sense electrodes 50, 52, 54 and 56 is held at virtual ground by being electrically connected to an inverting input terminal of an operational amplifier containing a capacitive feedback loop, the non-inverting input terminal being connected to ground. By placing first, second and third ground conductors between drive electrode 60 and sense electrodes 50, 52, 54 and 56, and between sense electrodes 50, 52, 54 and 56, erroneous readings arising from undesired electrical coupling between drive electrode 60 and sense electrodes 50, 52, 54 and 56 is virtually, if not entirely, eliminated, thereby reducing or eliminating the occurrence of spurious or erroneous capacitive sensing events arising from the effects of humidity or condensation.

FIG. 7 is a top plan view of the upper surface of portable device 10 employing input device 19 according to one embodiment. Device 10 may be a cellular phone, a PDA, an MP3 player, or any other handheld, portable or stationary device employing one or more internal processors. For purposes of illustration, a preferred embodiment is shown in FIG. 7, which is portable. Portable device 10 comprises outer housing 10, which includes display 14, keys 16 and control and capacitive sensing input device 19. Capacitive sensing input device 19 and keys 16 provide inputs to processor 102 (not shown in FIG. 7), and processor 102 controls display 14. The upper surface of capacitive sensing input device 19 has sensing areas labeled A, B, C, D and E in locations overlying sense electrodes 56, 50, 52 and 54, respectively. Drive electrode 60 is disposed beneath central area A. By moving a finger across and/or pushing down on sensing areas A, B, C, D or E, a user may effect scrolling and/or clicking functionality provided by underlying electrode array 59, and capacitance sensing circuit 104 and processor 102 operably connected thereto.

In another embodiment, buttons or collapsible dome switches may also be provided beneath areas A, B, C, D and E as disclosed in U.S. patent application Ser. No. 11/923,653 to Orsley et al. entitled “Control and Data Entry Apparatus” filed Oct. 24, 2007, the entirety of which is hereby incorporated by reference herein. Such sensing areas and buttons may also be used to control any function defined by the manufacturer of the portable device.

In one embodiment employing the principles described above respecting FIG. 2, and as further illustrated in FIG. 8, the values of the individual capacitances between sense plate 20 and sense electrodes 50, 52, 54 and 56 mounted on substrate 30 are monitored or measured by capacitance sensing circuit 104 located within portable device 10, as are the operating states of any additional switches provided in conjunction therewith. In a preferred embodiment, a 125 kHz square wave drive signal is applied to sense plate 20 by capacitance sensing circuit 104 through drive electrode 60 so that the drive signal is applied continuously to sense plate 20, although those skilled in the art will understand that other types of drive signals may be successfully employed. Indeed, the drive signal need not be supplied by capacitance sensing circuit 104, and in some embodiments is provided by a separate drive signal circuit. In a preferred embodiment, however, the drive signal circuit and the capacitance sensing circuit are incorporated into a single circuit or integrated circuit.

Capacitive sensing circuit 104 may be configured to require a series of capacitance changes indicative of movement of a user's finger circumferentially around upper surface 27 of capacitive sensing input device 19 over a minimum arc, such as 45, 90 or 180 degrees, or indeed any other predetermined suitable range of degrees that may be programmed by a user in capacitive sensing circuit 104, before a scrolling function is activated or enabled.

FIG. 8 further illustrates electrode array 59 and its connection to capacitance sensing circuit 104, host processor 102, and the schematic arrangement of electrically conductive drive electrode trace or conductor 83, electrically conductive sense electrode traces or conductors 81, 82, 84 and 86, and electrically conductive fixed potential or ground traces or conductors 85, 70, 72 and 74 disposed on substrate 30, and the electrical connections of such traces and electrodes to capacitance sensing circuit 104, which as described above in a preferred embodiment is an integrated circuit especially designed for the purpose of sensing changes in capacitance and reporting same to host processor 102. FIG. 8 also illustrates schematically the connections between capacitance sensing circuit 104 and host processor 102, and between host processor 102 and display 14. As illustrated, electrical conductors 81-86 couple sense and drive electrodes 50, 52, 54, 56 and 60, and fixed potential or ground conductors 70, 72 and 74, to capacitance sensing circuit 104, which in turn is operably coupled to other circuit disposed in device 10.

In the embodiments illustrated in FIGS. 5 and 8, substrate 30 has four peripheral pie-shaped electrodes 50, 52, 54 and 56 disposed thereon and surrounding drive electrode 60, all of which are preferably fabricated from a layer of conductive metal (typically copper) disposed on or in substrate 30 according to any of the various techniques described above, or using other suitable techniques known to those skilled in the art. Sense plate 20, if present, overlies, and in a resting non-actuated position is spaced apart from, electrodes 50, 52, 54, 56 and 60. It should be noted that while the embodiments disclosed in the Figures employ four peripheral pie-shaped electrodes and one central or drive electrode, two, three, five or other numbers of such structures or elements may instead be employed, as may electrodes having different shapes and configurations than those shown explicitly in the Figures.

As illustrated in FIG. 8, peripheral sense electrodes 50, 52, 54 and 56 and drive electrode 60 disposed on or in substrate 30 are electrically coupled to capacitance sensing circuit 104, which in turn produces output signals routed to host processor 102 via, for example, a serial I²C-compatible or Serial Peripheral Interface (SPI) bus, where such signals are indicative of the respective capacitances measured between sense plate 20 and sense electrodes 50, 52, 54 and 56. In the case where capacitance sensing circuit 104 is an Avago AMRI-2000 integrated circuit, the AMRI-2000 may be programmed to provide output signals to host processor 102 that, among other possibilities, are indicative of the amount of, or change in the amount of, spatial deflection of sense plate 20 (e.g., dX and/or dY) or the number and/or type of clicks or scrolling sensed with this number potentially dynamically variable based upon the speed of the sweep of the finger. Host processor 102 may use this information to control display 14 as discussed above. Circuit 104 may be any appropriate capacitance sensing circuit or integrated circuit and may, for example, correspond to those employed in some of the above-cited patent applications. Capacitance sensing circuit 104 may also be configured to detect the grounding of any of electrodes 50, 52, 54, 56 and 60.

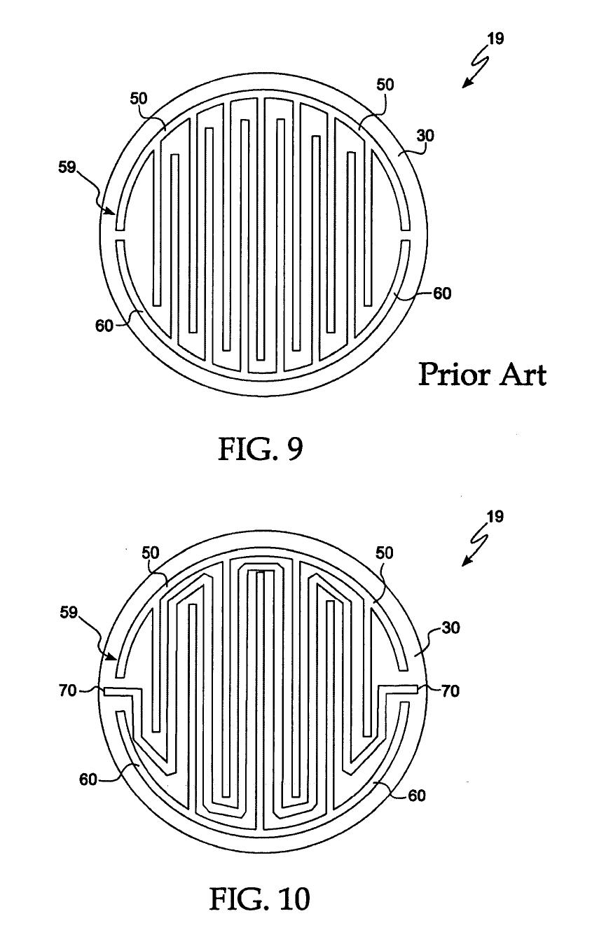

FIG. 9 shows a capacitive sense switch or button typical of the prior art, where input device 19 comprises substrate 30 upon which are disposed drive electrode 60 and sense electrode 50. As shown, drive electrode 60 comprises electrically conductive traces or conductors disposed upon or in substrate 30 that are interleaved with, but physically separated from, corresponding interleaved electrode conductors of sense electrode 50. Not shown in FIG. 9 is a membrane or switch cover formed of an electrically insulative material disposed over substrate 30, drive electrode 60 and sense electrode 50, which in actual practice would be provided, and upon which a user's finger would rest to actuate or trigger capacitance sensing circuit operatively connected to sense electrode 50 and drive electrode 60. The placement of a user's finger over sense electrode 50 and drive electrode 60 and in proximity thereto changes the capacitance sensed by such capacitance sensing circuit, and may be employed, for example, to actuate a switch or control another device operatively connected to the capacitance sensing circuit.

FIG. 10 shows one embodiment of a capacitive sense switch or button of the invention, where input device 19 comprises substrate 30 upon which are disposed drive electrode 60 and sense electrode 50 and electrically conductive trace or conductor. As shown, drive electrode 60 comprises electrically conductive fixed potential or ground trace or conductor 70 interspersed between interleaved sense electrode 50 and drive electrode 60. As shown in FIG. 10, fixed potential or ground trace or conductor 70 is positioned between the various interleaved segments of sense electrode 50 and drive electrode 60. As in FIG. 9, not shown in FIG. 10 is a membrane or switch cover disposed over substrate 30, drive electrode 60, sense electrode 50 and fixed potential or ground trace or conductor 70, which in actual practice would be provided, and upon which a user's finger would rest to actuate or trigger capacitance sensing circuit operatively connected to sense electrode 50 and drive electrode 60. The placement of a user's finger over sense electrode 50 and drive electrode 60 and in proximity thereto changes the capacitance sensed by such capacitance sensing circuit, and may be employed, for example, to actuate a switch or control another device operatively connected to the capacitance sensing circuit. fixed potential or ground trace or conductor 70 operates to intercept or capture undesired electrical fields arising from humidity or condensation on or in proximity to substrate 30, sense electrode 50 and drive electrode 60 in a manner similar that described hereinabove respecting the embodiments illustrated in FIGS. 4 and 6. In the embodiment illustrated in FIG. 10, a typical capacitance established between sense electrode 50 and drive electrode 60 is about 0.5 pF where no user's finger is in proximity thereto. Placement of a user's finger in proximity to electrodes 50 and 60 typically causes such a capacitance to be reduced to about 0.25 pF, which reduction in capacitance is sensed by capacitance sensing circuit 104.

While the primary use of the input device of the present invention is believed likely to be in the context of relatively small portable devices, it may also be of value in the context of larger devices, including, for example, keyboards associated with desktop computers or other less portable devices such as exercise equipment, industrial control panels, washing machines, or equipment or devices configured for use in moist, humid, sea-air, muddy or underwater environments. Similarly, while many embodiments of the invention are believed most likely to be configured for manipulation by a users fingers, some embodiments may also be configured for manipulation by other mechanisms or body parts. For example, the invention might be located on or in the hand rest of a keyboard and engaged by the heel of the user's hand.

Although some embodiments described herein comprise a single substrate upon which drive and sense electrodes are mounted or disposed, it is also contemplated that the various sense and drive electrodes may be disposed or mounted upon separate or multiple substrates located beneath sense plate 20 or layer 32. Note further that multiple drive electrodes may be employed in various embodiments of the invention.

The term “capacitive sensing input device” as it appears in the specification and claims hereof is not intended to be construed or interpreted as being limited solely to a device or component of a device capable of effecting both control and data entry functions, but instead is to be interpreted as applying to a device capable of effecting either such function, or both such functions.

Note further that included within the scope of the present invention are methods of making and having made the various components, devices and systems described herein.

The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations and modifications of the foregoing embodiments of the present invention not set forth explicitly herein will nevertheless fall within the scope of the present invention.

I claim:

1. A capacitive sensing input device, comprising:
at least one substrate;
a drive electrode disposed on the substrate;
at least one sense electrode disposed on the substrate and electrically isolated from the drive electrode, at least portions of the sense electrode being separated from the drive electrode by a first gap;
at least one electrically conductive fixed potential or ground conductor disposed in at least portions of the first gap between the sense electrode and the drive electrode;
an electrically insulative touch surface disposed above the substrate, the drive electrode and the sense electrode, the touch surface being separated from the drive electrode by a second gap;
wherein the sense electrode, the drive electrode, the fixed potential or ground conductor and the touch surface are configured respecting one another to at least one of prevent, inhibit and diminish direct electrical coupling through water or water vapor disposed between the sense electrode and the drive electrode or atop, beneath or adjacent to the touch surface.

2. The capacitive sensing input device of claim 1, wherein the first gap ranges between about 0.2 mm and about 2 mm, between about 0.15 mm and about 3 mm, and between about 0.10 mm and about 4 mm.

3. The capacitive sensing input device of claim 1, wherein the second gap ranges between about 0.1 mm and about 1 mm.

4. The capacitive sensing input device of claim 1, wherein the at least one sense electrode comprises a plurality of electrically conductive sense electrodes.

5. The capacitive sensing input device of claim 1, further comprising a drive signal circuit configured to provide an electrical drive signal to the drive electrode.

6. The capacitive sensing input device of claim 1, further comprising a capacitance sensing circuit operably coupled to the sense electrode and configured to detect changes in capacitance occurring therein or thereabout.

7. The capacitive sensing device of claim 5 or 6, wherein the drive signal circuit or the capacitance sensing circuit is incorporated into an integrated circuit.

8. The capacitive sensing input device of claim 1, wherein the sense electrode comprises four sense electrodes arranged about an outer periphery of the drive electrode, and the ground conductor comprises one or more ground conductors disposed between at least portions of the outer periphery and the four sense electrodes, and between at least portions of the four sense electrodes.

9. The capacitive sensing input device of claim 1, wherein the device is at least one of a laptop computer, a personal data assistant (PDA), a mobile telephone, a radio, an MP3 player, a portable music player, a pointing device and a mouse.

10. The capacitive sensing device of claim 1, wherein the device is incorporated into and forms a portion of a stationary device, the stationary device being one of an exercise machine, an industrial control, a control panel, an outdoor control device and a washing machine.

11. The capacitive sensing device of claim 1, wherein the device is a capacitive sensing switch, the drive electrode and the sense electrode comprise interleaved conductors, and the ground conductor is disposed between at least portions of the interleaved conductors.

12. A capacitive sensing input device, comprising:
at least one substrate;
a drive electrode disposed on the substrate;
at least one sense electrode disposed on the substrate and electrically isolated from the drive electrode, at least portions of the sense electrode being separated from the drive electrode by a first gap;
at least one electrically conductive fixed potential or ground conductor disposed in at least portions of the first gap between the sense electrode and the drive electrode;
an electrically conductive sense plate disposed above the substrate, the drive electrode and the sense electrode, the sense plate being separated from the drive electrode by a second gap;
wherein the sense electrode, the drive electrode, the fixed potential or ground conductor and the sense plate are configured respecting one another to at least one of prevent, inhibit and diminish direct electrical coupling through water or water vapor disposed between the sense electrode and the drive electrode or atop, beneath or adjacent to the sense plate.

13. The capacitive sensing input device of claim 12, wherein the first gap ranges between about 0.2 mm and about 2 mm, between about 0.15 mm and about 3 mm, and between about 0.10 mm and about 4 mm.

14. The capacitive sensing input device of claim 12, wherein the second gap ranges between about 0.1 mm and about 1 mm.

15. The capacitive sensing input device of claim 12, wherein the at least one sense electrode comprises a plurality of electrically conductive sense electrodes.

16. The capacitive sensing input device of claim 12, further comprising a drive signal circuit configured to provide an electrical drive signal to the drive electrode.

17. The capacitive sensing input device of claim 12, further comprising a capacitance sensing circuit operably coupled to the sense electrode and configured to detect changes in capacitance occurring therein or thereabout.

18. The capacitive sensing device of claim 16 or 17, wherein the drive signal circuit or the capacitance sensing circuit is incorporated into an integrated circuit.

19. The capacitive sensing input device of claim 12, wherein the sense electrode comprises four sense electrodes arranged about an outer periphery of the drive electrode, and the ground conductor comprises one or more ground conductors disposed between at least portions of the outer periphery and the four sense electrodes, and between at least portions of the four sense electrodes.

20. The capacitive sensing input device of claim 12, wherein the device is at least one of a laptop computer, a personal data assistant (PDA), a mobile telephone, a radio, an MP3 player, a portable music player, a pointing device and a mouse.

21. The capacitive sensing input device of claim 12, wherein the device is incorporated into and forms a portion of a stationary device, the stationary device being one of an exercise machine, an industrial control, a control panel, an outdoor control device and a washing machine.

22. The capacitive sensing input device of claim 12, wherein the sense plate is substantially planar in shape and has a diameter ranging between about 10 mm and about 50 mm, or at least one of about 12 mm, about 14 mm, about 16 mm, about 18 mm, about 20 mm, about 30 mm and about 40 mm.

23. A method of making a capacitive sensing input device, comprising:
providing at least one substrate;
providing a drive electrode and disposing the drive electrode on the substrate;
providing at least one sense electrode and disposing the sense electrode on the substrate such that the sense electrode is electrically isolated from the drive electrode and at least portions of the sense electrode are separated from the drive electrode by a first gap;
providing at least one electrically conductive fixed potential or ground conductor and disposing the fixed potential or ground conductor in at least portions of the first gap between the sense electrode and the drive electrode;
providing an electrically insulative touch surface and positioning the touch surface above the substrate, the drive electrode and the sense electrode such that the touch surface is separated from the drive electrode by a second gap, and
configuring the sense electrode, the drive electrode, the fixed potential or ground conductor and the touch surface respecting one another to at least one of prevent, inhibit and diminish direct electrical coupling through water or water vapor disposed between the sense electrode and the drive electrode or atop, beneath or adjacent to the touch surface.

24. A method of making a capacitive sensing input device, comprising:
providing at least one substrate;
providing a drive electrode and disposing the drive electrode on the substrate;
providing at least one sense electrode and disposing the sense electrode on the substrate such that the sense electrode is electrically isolated from the drive electrode and at least portions of the sense electrode are separated from the drive electrode by a first gap;
providing at least one electrically conductive fixed potential or ground conductor and disposing the fixed potential or ground conductor in at least portions of the first gap between the sense electrode and the drive electrode;
providing an electrically conductive sense plate and disposing the sense plate above the substrate, the drive electrode and the sense electrode such that the sense plate is separated from the drive electrode by a second gap, and
configuring the sense electrode, the drive electrode, the fixed potential or ground conductor and the sense plate respecting one another to at least one of prevent, inhibit and diminish direct electrical coupling through water or water vapor disposed between the sense electrode and the drive electrode or atop, beneath or adjacent to the sense plate.

25. A method of preventing, inhibiting or diminishing direct electrical coupling through water or water vapor disposed between a sense electrode and a drive electrode, comprising:
providing at least one electrically conductive fixed potential or ground conductor and disposing the fixed potential or ground conductor in at least portions of a gap between the sense electrode and the drive electrode, and
configuring the sense electrode, the drive electrode and the fixed potential or ground conductor respecting one another to at least one of prevent, inhibit and diminish direct electrical coupling through water or water vapor disposed between the sense electrode and the drive electrode.
